(19) United States
(12) Patent Application Publication
(10) Pub. No.: US 2020/0320805 A1
(43) Pub. Date: Oct. 8, 2020

(54) BAUD RATE OBTAINING METHOD AND APPARATUS

(71) Applicant: AUTEL INTELLIGENT TECHNOLOGY CORP., LTD., Shenzhen (CN)

(72) Inventor: Zhibing PENG, Shenzhen (CN)

(21) Appl. No.: 16/909,469

(22) Filed: Jun. 23, 2020

Related U.S. Application Data
(63) Continuation of application No. PCT/CN2019/127416, filed on Dec. 23, 2019.

(30) Foreign Application Priority Data
Dec. 24, 2018 (CN) 201811582021.3

(51) Int. Cl. G07C 5/08; G05B 19/042

(52) U.S. Cl. CPC G07C 5/0808; G05B 19/0428; B60R 16/0232; G05B 2219/2637; G05B 2219/24024

(57) ABSTRACT

The present invention relates to the field of industrial fieldbus communications technologies, and in particular, to a baud rate obtaining method and apparatus. The method includes: starting a monitoring mode; monitoring a detection signal from a vehicle electronic control unit in the monitoring mode; determining at least one to-be-tested baud rate related to the detection signal according to the detection signal; parsing the detection signal by sequentially using the at least one to-be-tested baud rate; and when the detection signal is correctly parsed by using a specific to-be-tested baud rate in the at least one to-be-tested baud rate, determining that the specific to-be-tested baud rate is a baud rate corresponding to the vehicle electronic control unit. In this implementation, a specific baud rate is adopted for receiving CAN bus data. During the whole process, no waveform data is actively sent to a CAN bus, thereby ensuring stability of the CAN bus. In addition, identification of a baud rate of the CAN bus is completed by a vehicle communications interface device independently, thereby shortening a time of entering a system during link communication.

This application is a continuation application of International Application No. PCT/CN2019/127416, filed on Dec. 23, 2019, which claims priority of Chinese Patent Application No. 201811582021. 3, filed on Dec. 24, 2018, which is incorporated herein by reference in its entirety.

### BACKGROUND

### Technical Field

The present application relates to the field of industrial fieldbus communications technologies, and in particular, to a baud rate obtaining method and apparatus.

### Related Art

Currently, a controller area network (CAN) bus protocol has become a bus standard of a vehicle computer control system and an embedded industrial controller area network. Various operating systems have integrated a large quantity of board support packages. Moreover, a large quantity of manufacturers provide corresponding board drivers, also provide support for the CAN bus protocol, and in addition, support CAN device driving in a character device form. However, a baud rate of the CAN bus is not unique. When the baud rate of the CAN bus does not match a baud rate of a CAN device, normal communication cannot be performed. When a vehicle and a vehicle diagnostic device communicate with each other through the CAN bus, a same baud rate is also needed. In an actual application, different CAN buses have different baud rates. Usually, a baud rate of a vehicle is fixed at delivery. If the baud rate of the CAN bus is not consistent with the baud rate of the vehicle, the vehicle diagnostic device cannot communicate with the vehicle through the CAN bus.

To resolve the foregoing problems, in the related art, in a vehicle diagnosis process, different baud rates are adopted for sending data to a CAN bus in a scanning manner. If correct response data can be received, a current baud rate is an actual baud rate of the CAN bus. The baud rate used for scanning, a scanned pin, the sent data, and the response data are all determined by a host computer.

In a process of implementing the present invention, it is found that there are the following problems in the related art: Stability of a bus is interfered with when different baud rates are adopted for sending data to the CAN bus. Consequently, a vehicle system fault is easily caused. In addition, a process of determining the baud rate of the CAN bus is controlled by the host computer, and is completed during link communication. A time of entering a system is prolonged.

### SUMMARY

A technical problem to be resolved by the present invention is to provide a baud rate obtaining method and apparatus, to resolve problems, in the related art, that stability of a CAN bus is poor, and that a time of entering a system is long when a baud rate of the CAN bus is obtained.

According to an aspect of an embodiment of the present invention, a baud rate obtaining method is provided, applied to a vehicle communications interface device, where the method includes:

starting a monitoring mode;

monitoring a detection signal from a vehicle electronic control unit in the monitoring mode;

determining at least one to-be-tested baud rate related to the detection signal;

parsing the detection signal by sequentially using the at least one to-be-tested baud rate; and

when the detection signal is correctly parsed by using a specific to-be-tested baud rate in the at least one to-be-tested baud rate, determining that the specific to-be-tested baud rate is a baud rate corresponding to the vehicle electronic control unit.

Optionally, the determining at least one to-be-tested baud rate related to the detection signal includes:

obtaining an OBD pin sending the detection signal; and

determining the at least one to-be-tested baud rate related to the detection signal according to a correspondence between an OBD pin and a baud rate and the obtained OBD pin.

Optionally, the correspondence between an OBD pin and a baud rate is preset or obtained from a host computer.

Optionally, the parsing the detection signal by sequentially using the at least one to-be-tested baud rate includes:

parsing the detection signal in a CAN controller by sequentially using a to-be-tested baud rate in the at least one to-be-tested baud rate; and

reading a status register in the CAN controller, to determine whether the detection signal is correctly parsed by using the to-be-tested baud rate.

Optionally, the starting a monitoring mode specifically includes:

starting the monitoring mode when the vehicle communications interface device is powered on.

Optionally, the monitoring a detection signal from a vehicle electronic control unit in the monitoring mode specifically includes:

monitoring a group of pins according to a preset pin list, to obtain the detection signal through the monitored pins.

According to another aspect of the embodiment of the present invention, a baud rate obtaining apparatus is provided, applied to a vehicle communications interface device, where the apparatus includes an OBD interface, a CAN transceiver and a primary controller.

The OBD interface is configured to monitor a detection signal from a vehicle electronic control unit when the vehicle communications interface device starts a monitoring mode, and send the detection signal to the CAN transceiver.

The CAN transceiver is configured to send the detection signal to the primary controller.

The primary controller is configured to determine at least one to-be-tested baud rate related to the detection signal according to the detection signal, parse the detection signal by sequentially using the at least one to-be-tested baud rate, and when the detection signal is correctly parsed by using a specific to-be-tested baud rate in the at least one to-be-tested baud rate, determine that the specific to-be-tested baud rate is a baud rate corresponding to the vehicle electronic control unit.

Optionally, the primary controller includes a CAN controller and an MCU.

The MCU is configured to determine the at least one to-be-tested baud rate related to the detection signal according to the detection signal, and send the at least one to-be-tested baud rate to the CAN controller. The CAN controller is configured to parse the detection signal by sequentially using the at least one to-be-tested baud rate, and when the detection signal is correctly parsed by using the specific to-be-tested baud rate in the at least one to-be-tested baud rate, determine that the specific to-be-tested baud rate is the baud rate corresponding to the vehicle electronic control unit.

Optionally, the MCU is specifically configured to:

obtain an OBD pin sending the detection signal; and

determine the at least one to-be-tested baud rate related to the detection signal according to a correspondence between an OBD pin and a baud rate and the obtained OBD pin.

Optionally, the correspondence between an OBD pin and a baud rate is preset or obtained from a host computer.

Optionally, the CAN controller is specifically configured to:

parse the detection signal by sequentially using a to-be-tested baud rate in the at least one to-be-tested baud rate; and

read a status register in the CAN controller, to determine whether the detection signal is correctly parsed by using the to-be-tested baud rate.

Optionally, the starting a monitoring mode specifically includes:

starting the monitoring mode when the vehicle communications interface device is powered on.

Optionally, the OBD interface is specifically configured to:

when the vehicle communications interface device starts the monitoring mode, monitor a group of pins according to a preset pin list, to obtain the detection signal by using the monitored pins.

In the embodiment of the present invention, after the vehicle communications interface device starts the monitoring mode, the detection signal from the vehicle electronic control unit is monitored, the at least one to-be-tested baud rate related to the detection signal is then determined, the detection signal is parsed by sequentially using the at least one to-be-tested baud rate; and when the detection signal is correctly parsed by using the specific to-be-tested baud rate in the at least one to-be-tested baud rate, it is determined that the specific to-be-tested baud rate is the baud rate corresponding to the vehicle electronic control unit. In the implementations, a specific baud rate is adopted for receiving CAN bus data. During the whole process, no waveform data is actively sent to a CAN bus, thereby ensuring stability of the CAN bus. In addition, identification of a baud rate of the CAN bus is completed by the vehicle communications interface device independently, thereby shortening a time of entering a system during link communication.

### BRIEF DESCRIPTION OF THE DRAWINGS

One or more embodiments are described by way of example with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of a baud rate obtaining apparatus according to an embodiment of the present invention;

FIG. 2 is a flowchart of a method of determining at least one to-be-tested baud rate related to the detection signal according to an embodiment of the present invention;

FIG. 3 is a flowchart of a method of parsing the detection signal by sequentially using the at least one to-be-tested baud rate according to an embodiment of the present invention; and

FIG. 4 is a flowchart of a method of obtaining a baud rate corresponding to the vehicle communications interface device according to an embodiment of the present invention.

### DETAILED DESCRIPTION

To make the objectives, technical solutions, and advantages of the present invention clearer and more comprehensible, the following further describes the present invention in detail with reference to the accompanying drawings and embodiments. It should be understood that the specific embodiments described herein are merely used to explain the present invention but are not intended to limit the present invention.

It should be noted that, if there is no conflict, various features in the embodiments of the present invention may be combined with each other, and all fall within the protection scope of the present invention. In addition, although functional modules are divided in a schematic apparatus diagram, and a logical sequence is shown in a flowchart, in some cases, shown or described steps may be performed through module division different from that in the schematic apparatus diagram or in a sequence different from that in the flowchart.

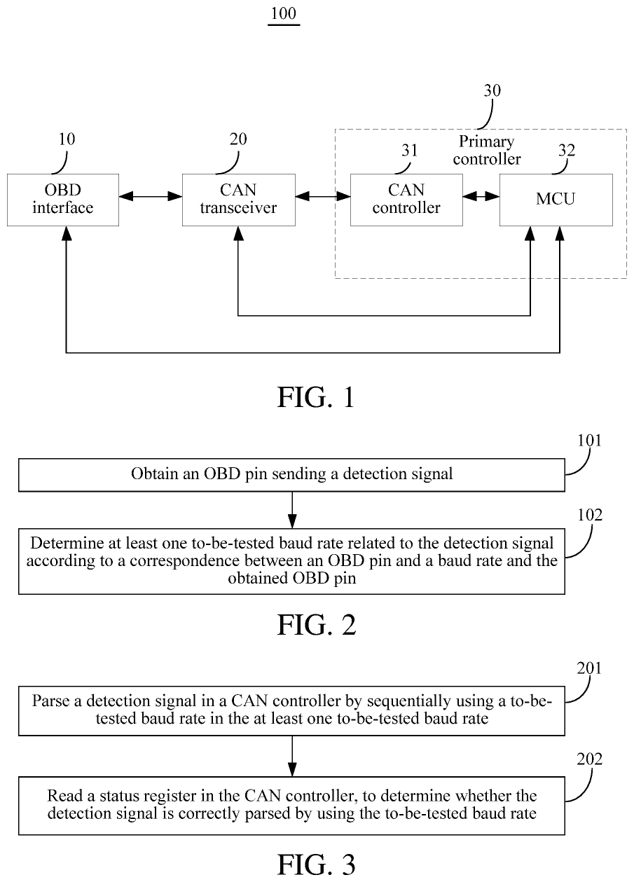

FIG. 1 is a schematic structural diagram of a baud rate obtaining apparatus according to an embodiment of the present invention. The apparatus 100 may be applied to a vehicle communication interface (VCI) device, and includes an OBD interface 10, a CAN transceiver 20 and a primary controller 30.

The OBD interface 10 is respectively connected to the CAN transceiver 20 and the primary controller 30. An OBD interface of the VCI is configured to connect an OBD interface on a vehicle through an OBD communications cable, thereby connecting an electronic control unit in the vehicle. The OBD interface 10 is configured to monitor a detection signal from a vehicle electronic control unit (ECU) when the vehicle communications interface device starts a monitoring mode, and send the detection signal to the CAN transceiver 20. The detection signal is used to determine at least one to-be-tested baud rate related to the vehicle electronic control unit, to determine a baud rate of the vehicle electronic control unit according to the at least one to-be-tested baud rate. The detection signal may be specifically a digital signal or an analog signal. A specific manner of monitoring the detection signal from the vehicle electronic control unit in the monitoring mode may be monitoring a group of pins according to a preset pin list, to obtain the detection signal through the monitored pins. The detection signal flows to the OBD interface 10 through the monitored pins, each of the monitored pins separately corresponding to a detection signal. The detection signal comes from an ECU in the vehicle connected to the monitored pin. A quantity of pins connected to the ECU may be one, two, or more. That the vehicle communications interface device starts a monitoring mode may be specifically starting the monitoring mode when the vehicle communications interface device is powered on.

In this embodiment, the OBD interface 10 may include an OBD II pin selection module and a pin. The pin is configured to directly connect an OBD II interface communications cable. The OBD II pin selection module is connected to all pins, is configured to select one or more pins for monitoring a detection signal transmitted thereon, and may further be connected to the CAN transceiver 20. The OBD II pin selection module may send the monitored detection signal to the CAN transceiver 20 under the control of the primary controller 30. To ensure that a deformation range of a parameter of the transmitted detection signal is controllable, a baud rate passed by the OBD II pin selection module is usually greater than or equal to 2 MHZ, and a voltage value input by the OBD II pin selection module is greater than or equal to 12 V. Certainly, in an actual application, the baud rate and the voltage value may be adjusted according to specific device parameters, but are not limited to the scopes required above. It should be noted that the OBD interface may include an OBD interface of any standard, such as an OBD interface and an OBD II interface, which is not limited herein.

The CAN transceiver 20 is connected to the OBD interface 10 and the primary controller 30 separately. In this embodiment, the CAN transceiver 20 belongs to a physical layer of a CAN bus, and is configured to receive the detection signal sent by the OBD interface 10, and send the detection signal to the primary controller 30. Optionally, the CAN transceiver 20 is further configured to perform data processing on the received detection signal, and send the detection signal after data processing to the primary controller 30. Specifically, the CAN transceiver 20 may convert a binary bitstream signal into a differential signal, and then send the differential signal. The CAN transceiver 20 may alternatively convert a differential signal into a binary bitstream signal, and then send the binary bitstream signal. In this embodiment, the detection signal is a differential signal. The CAN transceiver 20 obtains the differential signal from the OBD interface 10, converts the differential signal into a binary bitstream signal, and then sends the binary bitstream signal to the primary controller 30.

The primary controller 30 is configured to determine at least one to-be-tested baud rate related to the detection signal according to the detection signal sent by the CAN transceiver 20, parse the detection signal by sequentially using the at least one to-be-tested baud rate, and when the detection signal is correctly parsed by using a specific to-be-tested baud rate in the at least one to-be-tested baud rate, determine that the specific to-be-tested baud rate is a baud rate corresponding to the vehicle electronic control unit.

Referring to FIG. 2, that the primary controller 30 determines the at least one to-be-tested baud rate related to the detection signal according to the detection signal sent by the CAN transceiver 20 specifically includes the following steps.

Step 101: Obtain an OBD pin sending the detection signal.

The primary controller 30 obtains, by using the CAN transceiver 20 from the OBD interface 10, the OBD pin for sending the detection signal. The obtained OBD pin is specifically one or some of all pins included in the OBD interface 10.

Step 102: Determine at least one to-be-tested baud rate related to the detection signal according to a correspondence between an OBD pin and a baud rate and the obtained OBD pin.

The correspondence between an OBD pin and a baud rate may be preset or obtained from a host computer. Herein, the host computer in this embodiment of the present invention refers to a vehicle diagnostic device connected to the VCI, including a terminal, a PC, or the like. The host computer stores a correspondence between an identified pin of a CAN bus and a baud rate, that is, the correspondence between an OBD pin and a baud rate. The primary controller 30 may directly obtain the correspondence between an OBD pin and a baud rate from the host computer. The correspondence between an OBD pin and a baud rate may be specifically that an OBD pin corresponds to a baud rate, that an OBD pin corresponds to a baud rate within a range, or the like.

The determining at least one to-be-tested baud rate related to the detection signal according to a correspondence between an OBD pin and a baud rate and the obtained OBD pin specifically includes: looking up the obtained OBD pin in the correspondence between an OBD pin and a baud rate, and when a same OBD pin is found, obtaining a baud rate corresponding to the same OBD pin, where the obtained baud rate is a to-be-tested baud rate related to the detection signal. The to-be-tested baud rate refers to a baud rate used for baud rate identification of the CAN bus. In this embodiment, by first determining a to-be-tested baud rate, and then determining the baud rate of the CAN bus according to the to-be-tested baud rate, instead of adopting all baud rates to send data to a bus in a scanning manner, not only a time of baud rate identification of the CAN bus is shortened, but also stability of the CAN bus is ensured.

Referring to FIG. 3, that the primary controller 30 parses the detection signal by sequentially using the at least one to-be-tested baud rate specifically includes:

Step 201: Parse the detection signal in a CAN controller by sequentially using a to-be-tested baud rate in the at least one to-be-tested baud rate.

Step 202: Read a status register in the CAN controller, to determine whether the detection signal is correctly parsed by using the to-be-tested baud rate.

In this embodiment, the primary controller 30 determines, by using data information of the status register in the CAN controller, whether the detection signal is correctly parsed by using the to-be-tested baud rate. Specifically, the CAN controller obtains the detection signal from the CAN transceiver 20, the detection signal being a binary bitstream signal. The CAN controller parses the binary bitstream signal. The process includes operations such as comparison between signal transmission and signal reception, de-bit padding, and a CRC check. The CAN controller determines a mistake according to the parsed binary bitstream signal, determines that the detection signal is not correctly parsed by using the to-be-tested baud rate when a data frame of the parsed binary bitstream signal exists in an incorrectly placed bus status register, and determines that the detection signal is correctly parsed by using the to-be-tested baud rate when the data frame of the parsed binary bitstream signal exists in a correctly placed bus status register. In this case, the to-be-tested baud rate that can be used to correctly parse the detection signal is a baud rate corresponding to the vehicle electronic control unit.

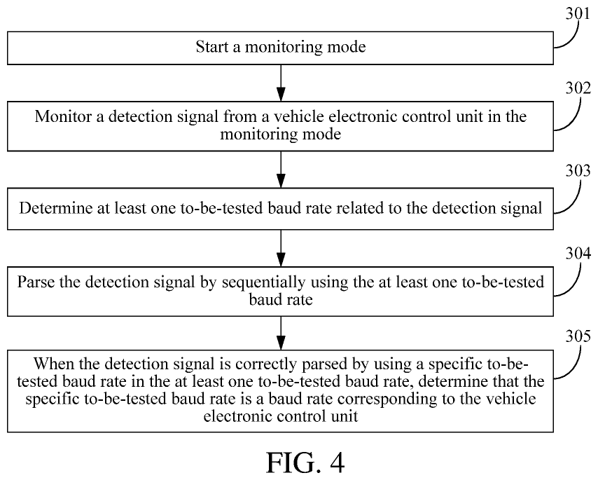

In this embodiment, the apparatus 100 is applied to the vehicle communications interface device. When the apparatus 100 obtains the baud rate of the CAN bus, that is, obtains the baud rate corresponding to the vehicle communications interface device, as shown in FIG. 4, the following steps are specifically included:

Step 301: Start a monitoring mode.

Step 302: Monitor a detection signal from a vehicle electronic control unit in the monitoring mode.

Step 303: Determine at least one to-be-tested baud rate related to the detection signal.

Step 304: Parse the detection signal by sequentially using the at least one to-be-tested baud rate.

Step 305: When the detection signal is correctly parsed by using a specific to-be-tested baud rate in the at least one to-be-tested baud rate, determine that the specific to-be-tested baud rate is a baud rate corresponding to the vehicle electronic control unit.

The specific process of the method executed in the foregoing step 301 to step 305 has the same concept as the functions implemented by the OBD interface 10, the CAN transceiver 20 and the primary controller 30. For details, refer to the foregoing embodiments.

In some embodiments, referring to FIG. 1, the primary controller 30 includes a CAN controller 31 and an MCU 32. The CAN controller 31 is connected to the CAN transceiver 20 and the MCU 32, and the MCU 32 is connected to the OBD interface 10, the CAN transceiver 20 and the CAN controller 31 separately. In the foregoing embodiments, the functions implemented by the CAN controller 31 and the MCU 32 are integrated into the primary controller 30. In this embodiment, a CAN controller 31 module and an MCU 32 module that are independent may be set.

The MCU 32 is configured to determine the at least one to-be-tested baud rate related to the detection signal according to the detection signal, and send the at least one to-be-tested baud rate to the CAN controller 31. The CAN controller 31 is configured to parse the detection signal by sequentially using the at least one to-be-tested baud rate. When the detection signal is correctly parsed by using the specific to-be-tested baud rate in the at least one to-be-tested baud rate, the MCU 32 is configured to determine that the specific to-be-tested baud rate is the baud rate corresponding to the vehicle electronic control unit. In this embodiment, the CAN controller 31 is specifically configured to perform the foregoing step 201 and step 202. The MCU 32 is specifically configured to perform the foregoing step 101 and step 102. For details, refer to the foregoing embodiments.

Optionally, the MCU 32 is further configured to store or invoke, from a memory of the VCI, a relationship correspondence list of an OBD II bus, a CAN bus, and a pin (for example, 6&14, that is, a No. 6 pin in an OBD II interface corresponds to a CANH bus, and a No. 14 pin in the OBD II interface corresponds to a CANL bus; 12&13, that is, a No. 12 pin in the OBD II interface corresponds to the CANH bus, and a No. 13 pin in the OBD II interface corresponds to the CANL bus), store a CAN bus baud rate list (for example, 33333/125000/250000/500000/1000000 bps, where the numerals represent a quantity of communications bits per second, for example, 250000 bps, that is, 250 K bits can be transmitted per second, each bit occupying 4 μs), and store a correspondence between the identified pin of the CAN bus and the baud rate. In some embodiments, the MCU 32 is connected to the host computer. For example, the MCU 32 is connected to the host computer through a communications interface of the VCI. The host computer may obtain, through a preset interface, list information stored in the MCU 32 from the MCU 32. In addition, the MCU 32 may obtain a correspondence between a pin and a baud rate from the host computer. After the to-be-tested baud rate that can be used to correctly parse the detection signal and the to-be-tested baud rate that cannot be used to correctly parse the detection signal are obtained according to the foregoing step 201 and step 202, matched and mismatched to-be-tested baud rates may be fed back to the host computer, to prevent the host computer from using an incorrect baud rate to send data to the CAN bus.

The embodiment of the present invention provides a baud rate obtaining apparatus, after the vehicle communications interface device starts the monitoring mode, the apparatus monitors the detection signal from the vehicle electronic control unit, then determines the at least one to-be-tested baud rate related to the detection signal, parses the detection signal by sequentially using the at least one to-be-tested baud rate; and when the detection signal is correctly parsed by using the specific to-be-tested baud rate in the at least one to-be-tested baud rate, determines that the specific to-be-tested baud rate is the baud rate corresponding to the vehicle electronic control unit. In this embodiment, a specific baud rate is adopted for receiving CAN bus data. During the whole process, no waveform data is actively sent to a CAN bus, thereby ensuring stability of the CAN bus. In addition, identification of a baud rate of the CAN bus is completed by a vehicle communications interface device independently, thereby shortening a time of entering a system during link communication.

Through the description of the foregoing embodiments, a person of ordinary skill in the art may clearly learn that the embodiments may be implemented by software in combination with a general-purpose hardware platform, or may certainly be implemented by hardware. A person of ordinary skill in the art may understand that all or some of the procedures of the methods of the foregoing embodiments are implemented by a computer program instructing relevant hardware. The program may be stored in a computer-readable storage medium. When the program is executed, the program may include the procedures of the embodiments of the foregoing methods. The foregoing storage medium may be a magnetic disk, an optical disc, a read-only memory (ROM), a random access memory (RAM), or the like.

It should be finally noted that the above embodiments are merely intended for describing the technical solutions of the present invention rather than limiting the present invention. Based on the idea of the present invention, the technical features in the foregoing embodiments or different embodiments may be combined, the steps may be implemented in any order, and many other changes in the different aspects of the present invention as described above may exist. For brevity, such changes are not provided in the detailed descriptions. Although the present invention is described in detail with reference to the foregoing embodiments, a person of ordinary skill in the art should understand that they can still make modifications to the technical solutions described in the foregoing embodiments or make equivalent substitutions to some technical features thereof, without essentially departing from scope of the technical solutions of the embodiments of the present invention.

What is claimed is:

1. A baud rate obtaining method, applied to a vehicle communications interface device, wherein the method comprises:
starting a monitoring mode;
monitoring a detection signal from a vehicle electronic control unit in the monitoring mode;
determining at least one to-be-tested baud rate related to the detection signal;
parsing the detection signal by sequentially using the at least one to-be-tested baud rate; and
when the detection signal is correctly parsed by using a specific to-be-tested baud rate in the at least one to-be-tested baud rate, determining that the specific to-be-tested baud rate is a baud rate corresponding to the vehicle electronic control unit.

2. The method according to claim 1, wherein the determining at least one to-be-tested baud rate related to the detection signal comprises:
obtaining an OBD pin sending the detection signal; and
determining the at least one to-be-tested baud rate related to the detection signal according to a correspondence between an OBD pin and a baud rate and the obtained OBD pin.

3. The method according to claim 2, wherein the correspondence between an OBD pin and a baud rate is preset or obtained from a host computer.

4. The method according to claim 1, wherein the parsing the detection signal by sequentially using the at least one to-be-tested baud rate comprises:
parsing the detection signal in a CAN controller by sequentially using a to-be-tested baud rate in the at least one to-be-tested baud rate; and
reading a status register in the CAN controller, to determine whether the detection signal is correctly parsed by using the to-be-tested baud rate.

5. The method according to claim 1, wherein the starting a monitoring mode comprises:
starting the monitoring mode when the vehicle communications interface device is powered on.

6. The method according to claim 1, wherein the monitoring a detection signal from a vehicle electronic control unit in the monitoring mode specifically comprises:
monitoring a group of pins according to a preset pin list, to obtain the detection signal through the monitored pins.

7. A baud rate obtaining apparatus, applied to a vehicle communications interface device, wherein the apparatus comprises: an OBD interface, a CAN transceiver and a primary controller, wherein
the OBD interface is configured to monitor a detection signal from a vehicle electronic control unit when the vehicle communications interface device starts a monitoring mode, and send the detection signal to the CAN transceiver;
the CAN transceiver is configured to send the detection signal to the primary controller; and
the primary controller is configured to determine at least one to-be-tested baud rate related to the detection signal according to the detection signal, parse the detection signal by sequentially using the at least one to-be-tested baud rate, and when the detection signal is correctly parsed by using a specific to-be-tested baud rate in the at least one to-be-tested baud rate, determine that the specific to-be-tested baud rate is a baud rate corresponding to the vehicle electronic control unit.

8. The apparatus according to claim 7, wherein the primary controller comprises: a CAN controller and an MCU, wherein
the MCU is configured to determine the at least one to-be-tested baud rate related to the detection signal according to the detection signal, and send the at least one to-be-tested baud rate to the CAN controller; and the CAN controller is configured to parse the detection signal by sequentially using the at least one to-be-tested baud rate, and when the detection signal is correctly parsed by using the specific to-be-tested baud rate in the at least one to-be-tested baud rate, determine that the specific to-be-tested baud rate is the baud rate corresponding to the vehicle electronic control unit.

9. The apparatus according to claim 8, wherein the MCU is specifically configured to:
obtain an OBD pin sending the detection signal; and
determine the at least one to-be-tested baud rate related to the detection signal according to a correspondence between an OBD pin and a baud rate and the obtained OBD pin.

10. The apparatus according to claim 9, wherein the correspondence between an OBD pin and a baud rate is preset or obtained from a host computer.

11. The apparatus according to claim 8, wherein the CAN controller is specifically configured to:
parse the detection signal by sequentially using a to-be-tested baud rate in the at least one to-be-tested baud rate; and
read a status register in the CAN controller, to determine whether the detection signal is correctly parsed by using the to-be-tested baud rate.

12. The apparatus according to claim 7, wherein the starting a monitoring mode specifically comprises:
starting the monitoring mode when the vehicle communications interface device is powered on.

13. The apparatus according to claim 7, wherein the OBD interface is specifically configured to:
when the vehicle communications interface device starts the monitoring mode, monitor a group of pins according to a preset pin list, to obtain the detection signal by using the monitored pins.
